(19) United States
(12) Patent Application Publication
(10) Pub. No.: US 2009/0210422 A1
(43) Pub. Date: Aug. 20, 2009

(54) Secure Database Access

(75) Inventors: Elaine Chen, Bellevue, WA (US); George Yan, Bellevue, WA (US); Kevin Schmidt, Issaquah, WA (US); Sanjay Jacob, Redmond, WA (US); Mark Yang, Sammamish, WA (US); Randy Dong, Issaquah, WA (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 12/031,936

(22) Filed: Feb. 15, 2008

(51) Int. Cl. G06F 17/30

(52) U.S. Cl. 707/9; 707/E17.014

(57) ABSTRACT

Secure database access may be provided. First, a first schema associated with a database having a second schema may be defined. Next, a user type may be defined. The user type may comprise a user type that does not require a log-in. The defined user type may then be associated with the defined first schema. Next, at least one permission may be granted to the user type to the database on a database level. The at least one permission may comprise a create procedure permission, a create table permission, or a create function permission. Then permission to the second schema may be denied to the user type. Next, a procedure may be received comprising a procedure that poses a high security risk to the database. The received procedure may then be executed as the defined user type. The received procedure may be executed using a wrapper procedure.

### BACKGROUND

Database security includes processes and procedures that protect a database from unintended activity. Unintended activity may be categorized as authenticated misuse, malicious attacks, or inadvertent mistakes made by authorized individuals or processes. Database security is also a specialty within the broader computer security discipline. Traditionally, databases have been protected from external connections by firewalls or routers on a network perimeter with the database environment existing on an internal network. Additional network security devices that detect and alert on malicious database protocol traffic include network intrusion detection systems along with host-based intrusion detection systems. Database security is more critical as networks have become more open.

### SUMMARY

This Summary is provided to introduce a selection of concepts in a simplified form that are further described below in the Detailed Description. This Summary is not intended to identify key features or essential features of the claimed subject matter. Nor is this Summary intended to be used to limit the claimed subject matter's scope.

Secure database access may be provided. First, a first schema associated with a database having a second schema may be defined. Next, a user type may be defined. The defined user type may then be associated with the defined first schema. Next, at least one permission may be granted to the user type to the database on a database level. The at least one permission may comprise, but is not limited to, a create procedure permission, a create table permission, or a create function permission. Then permission to the second schema may be denied to the user type and certain carefully selected permissions to the second schema may be granted to the user type. Next, a procedure may be received comprising a procedure that poses a high security risk to the database. The received procedure may then be executed as the defined user type. The received procedure may be executed using a wrapper procedure. The first schema may comprise a “sand box” that users may operate within. Embodiments of the invention may prevent a first schema user to overpass granted permissions into the second schema objects. The specific permissions granted to the second schema to the user type may be configured by a system administrator to relax a security level.

Both the foregoing general description and the following detailed description provide examples and are explanatory only. Accordingly, the foregoing general description and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present invention. In the drawings:

FIG. 1 is a block diagram of an operating environment;

FIG. 2 is a flow chart of a method for providing secure database access; and

FIG. 3 is a block diagram of a system including a computing device.

### DETAILED DESCRIPTION

The following detailed description refers to the accompanying drawings. Wherever possible, the same reference numbers are used in the drawings and the following description to refer to the same or similar elements. While embodiments of the invention may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the invention. Instead, the proper scope of the invention is defined by the appended claims.

Secure database access may be provided. Conventional systems may allow database users to author rules (e.g. statements written in SQL or Multidimensional Expressions (MDX)) that may generate stored procedures (SPs) based on the authored rules. There is a security risk, however, in conventional systems that users may author harmful rules that may then be generated into SPs and executed against a database.

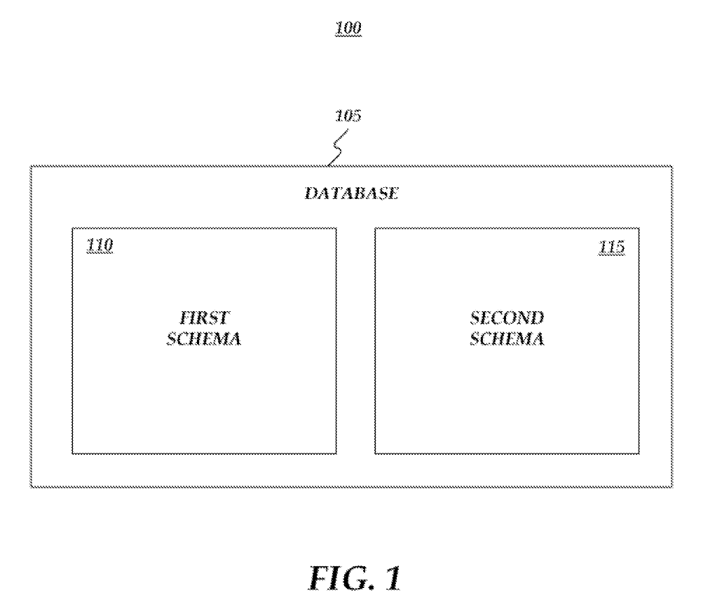

FIG. 1 shows an operating environment 100 having a database 105, a first schema 110, and a second schema 115. Second schema 115 may own, for example, all database objects in database 105. Consistent with embodiments of the present invention, first schema 110 may be configured to own only a portion of the database objects in database 105. Consequently, a user limited to first schema 110 may be forced to operate within a safe “sandbox” in database 105 and thus may be kept from executing harmful SPs against more critical or secured portions of database 105.

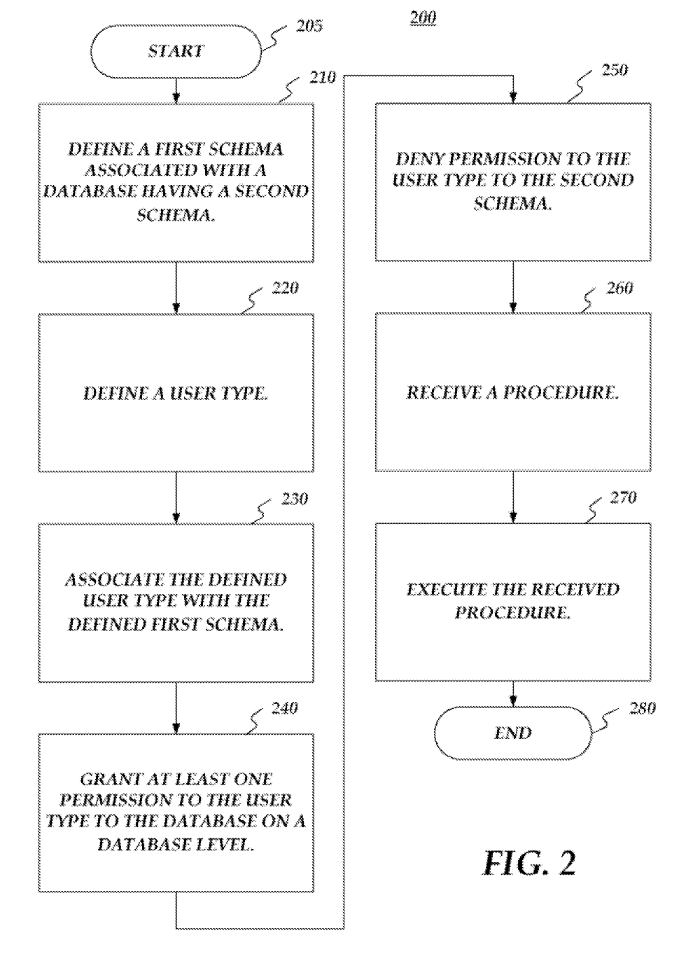

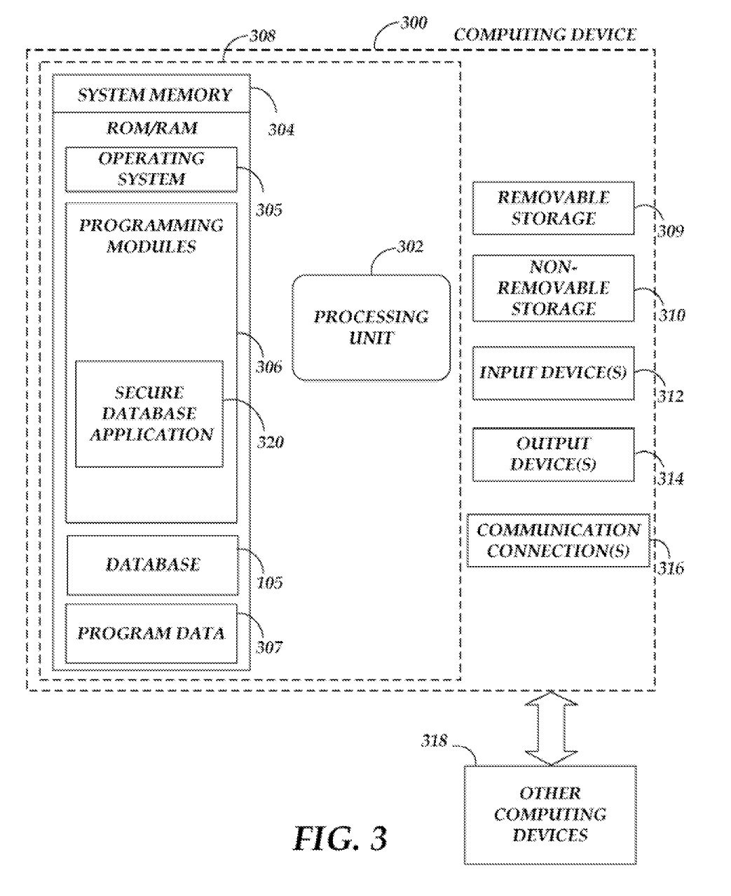

FIG. 2 is a flow chart setting forth the general stages involved in a method 200 consistent with an embodiment of the invention for providing secure database access. Method 200 may be implemented using a computing device 300 as described in more detail below with respect to FIG. 3. Ways to implement the stages of method 200 will be described in greater detail below. Method 200 may begin at starting block 205 and proceed to stage 210 where computing device 300 may define first schema 110 associated with database 105 having second schema 115. In order to protect database objects in database 105, embodiments of the invention may limit permissions that generated high security risk SPs can do. For example, only the generated SPs from the sandbox may locate in first schema 110. Other database objects may continue to reside in second schema 115 in database 105.

From stage 210, where computing device 300 defines first schema 110, method 200 may advance to stage 220 where computing device 300 may define a user type. For example, the user type may only be authorized to access first schema 110 (e.g. a Calc schema) and not second schema 115 (e.g. a dbo schema) in the same AppDB (e.g. database 105). The user type, for example, may be named “PPSPlanning2007LowPrivilegeSQLUser.” Because the user type may only be for internal use, there may be no need to create a login to associate with this user type. By eliminating the login to associate with this user type, embodiments of the invention may eliminate another security risk from the login use. Below is an example of code that may be used to create this user type.

CREATE USER PPSPlanning2007LowPrivilegeSQLUser
WITHOUT LOGIN
GO

Once computing device 300 defines the user type in stage 220, method 200 may continue to stage 230 where computing device 300 may associate the defined user type with defined first schema 110. For example, embodiments of the invention may authorize the user type access only to first schema 110 (e.g. Calc schema) and nothing else. This user type may also be authorized to access some data objects in second schema 115 (e.g. dbo schema). For example, embodiments of the invention may explicitly grant specific permissions for this user type to access both first schema 110 (e.g. Calc schema) and second schema 115 (e.g. dbo schema). Below is an example of code that may be used to authorize the user type access.

CREATE SCHEMA Calc AUTHORIZATION
PPSPlanning2007LowPrivilegeSQLUser
GO
(Note: CREATE SCHEMA statement may be the first
statement in any SQL batch file.)

After computing device 300 associates the defined user type with defined first schema 110 in stage 230, method 200 may proceed to stage 240 where computing device 300 may grant at least one permission to the user type to database 105 on a database level. For example, embodiments of the invention may determine what permissions the user type may need to have in the Calc schema (e.g. first schema 110) and the dbo schema (e.g. second schema 115). The user type may only be assigned, for example, enough permission to database objects in both schemas (e.g. first schema 110 and second schema 115) to do its job and maintain the sandbox.

Consistent with embodiments of the invention, the user type may be assigned a create procedure permission, a create table permission, or a create function permission. The aforementioned are examples and other permissions may be granted. For example, the user type may need to have permission to create a stored procedure in the Calc schema (e.g. first schema 110) and inside database 105. Below is an example of code that may be used to create procedure permission.

GRANT CREATE PROCEDURE TO
PPSPlanning2007LowPrivilegeSQLUser
GO

Note that CREATE PROCEDURE permission may only be granted at the database level, not at the schema level. However, to create the sandbox as described above, the user type may only be granted CREATE PROC on the Calc schema (e.g. first schema 110), not on all the schemas in database 105. The above statement may actually grant permissions to database 105, including all schemas (e.g. dbo and Calc). This issue is addressed below.

The user type may also be grated CREATE TABLE and CREATE FUNCTION permissions in the Calc schema (e.g. first schema 110). Like CREATE PROC permission, CREATE TABLE and CREATE FUNCTION permission may only be granted at the database level. Below are examples of code that may be used to create table permission and function permission.

GRANT CREATE TABLE TO
PPSPlanning2007LowPrivilegeSQLUser
GO
GRANT CREATE FUNCTION TO
PPSPlanning2007LowPrivilegeSQLUser
GO

From stage 240, where computing device 300 grants the at least one permission, method 200 may advance to stage 250 where computing device 300 may deny permission to the user type to second schema 115. For example, as stated above, the user type has been granted more permissions than it needs to remain in the sandbox. It has, for example, CREATE PROC/CREATE TABLE/CREATE FUNCTION in all schemas in database 105, which includes second schema 115 (e.g. the dbo schema). In order to limit the permission, embodiments of the invention may deny permission on the dbo schema (e.g. second schema 115) to PPSPlanning2007LowPrivilegeSQLUser to prevent the user type to create or alter SPs in any dbo schema. For example, embodiments of the invention may have a special SP “bsp_CreateExecuteSP” to be created in the dbo schema that should not be modified by the user type. Below is an example of code that may be used to deny permission on the dbo schema (e.g. second schema 115). For example, without the following DENY statement, the user type may create proc or create table in the dbo schema, which is counter to keeping the user type in the sandbox.

DENY ALTER ON SCHEMA::dbo TO
PPSPlanning2007LowPrivilegeSQLUser
GO

Once computing device 300 denies the permission to the user type in stage 250, method 200 may continue to stage 260 where computing device 300 may receive a procedure. For example, computing device 300 may receive the procedure from a user who authored rules that may generate the procedure based on the authored rules. The authored rules may be harmful to database 105, thus embodiments of the invention may keep the procedure within the sandbox. In other words, the procedure may comprise an SP that poses a high security risk to database 105. Computing device 300 may receive the procedure from the user who may be operating other computing device 318.

After computing device 300 receives the procedure in stage 260, method 200 may proceed to stage 270 where computing device 300 may execute the received procedure. For example, with a low privilege user (i.e. the aforementioned defined user type) on the Calc schema (e.g. the first schema) embodiments of the invention may use this special low privilege user to execute any high security risk SPs. Database 105 may be protected because the high security risk SP may be limited to the permissions granted to the low privilege user. In other words, the high security risk SP may be kept in the sandbox.

A data base server (e.g. an SQL server) may have a feature called “EXECUTE AS.” EXECUTE AS may be used in two ways: i) EXECUTE AS as a single statement; and ii) EXECUTE AS in a clause in a CREATE PROC statement. Embodiments of the invention may use CREATE PROC . . . EXECUTE AS. With this feature, embodiments of the invention can make SPs to be executed as the low privilege user at run time, hence achieve the goal of securing the high-risk generated SPs.

Embodiments of the invention may use, for example, a special SP “bsp_CreateExecuteSP”. This special SP may locate in the dbo schema (e.g. second schema 115) and be used as a wrapper call to create a generated SP. Embodiments of the invention may use this special SP to execute the received procedure. Below is an example of code that may be used to create the special SP in the dbo schema. (select user_name( ) shows ‘dbo’).

```
CREATE PROC dbo.bsp_CreateExecuteSP
@String nvarchar(max)
WITH EXECUTE AS ‘PPSPlanning2007LowPrivilegeSQLUser’
AS
BEGIN
      DECLARE @Count1 int
      CREATE TABLE #GeneratedCalc_Temp1 (count1 int)
      EXECUTE(@String)
      SELECT @Count1 = count1 from #GeneratedCalc_Temp1
      DROP TABLE #GeneratedCalc_Temp1
      IF @Count1 is NULL
          RETURN 0
      ELSE
          RETURN @Count1
END
Go
```

The above SP acts as wrapper SP to execute something at a special low privilege user at run time.

The following is the example of an SP (e.g. bsp_test3) that uses an EXECUTE AS in a clause in a CREATE PROC statement. The bsp_CreateExecuteSP may be used to create this SP (bsp_test3) in the Calc schema (e.g. first schema 110).

```
declare @string nvarchar(max)
set @String = N′
  create proc Calc.bsp_test3
  --with execute as “PPSPlanning2007LowPrivilegeSQLUser”
  as
      BEGIN
          declare @Out1 int
          select @Out1 = count(*) from dbo.D_Time
      INSERT INTO #GeneratedCalc_Temp1 values (@Out1)
END
-- Calc module uses bsp_CreateExecuteSP to create the bsp_test3
exec dbo.bsp_CreateExecuteSP
@String = @String
Go
```

“PPSPlanning2007LowPrivilegeSQLUser” may be commented out in bsp_test3 SP because embodiments of the invention may require bsp_CreateExecuteSP to execute bsp_test3. Consequently, there may be no need to add that line in bsp_test3. If embodiments of the invention execute bsp_test3 directly, such as exec Calc.bsp_test3, then this line may be needed. Otherwise bsp_test3 may be executed as dbo resulting in a security compromise.

It may, however, be too costly to parse the content users enter and add this clause with execute as “PPSPlanning2007LowPrivilegeSQLUser” to bsp_test3. Instead, embodiments of the invention may execute the generated SP (e.g. received procedure) from bsp_CreateExecuteSP so that it is executed as the user type (e.g. PPSPlanning2007LowPrivilegeSQLUser).

Furthermore, because “execute as” is a clause in CREATE PROC, it may not be an “execute as” statement, so a revert statement may not be used to revert the user. The following is an example of how embodiments of the invention may execute Calc.bsp_test3:

declare @rule_cmd nvarchar(2000)
declare @ReturnCount int
set @rule_cmd = N′exec calc.bsp_test3′
exec @ReturnCount = dbo.bsp_CreateExecuteSP
@String = @rule_cmd
SELECT ‘AffectedRuleCount:’ + CONVERT(nvarchar(20),
@ReturnCount)
Go

Upon execution of this example, the following error message may be generated: “The SELECT permission was denied on the object ‘D_Time’, database ‘AdventureWorks_Resorts_AppDB’, schema ‘dbo’.” This message may be generated because proper permission has not been granted to the user type to perform what it is told to do in bsp_test3: SELECT on dbo.D_Time.

Moreover, the temp table #GeneratedCalc_Temp1 in dbo.bsp_CreateExecuteSP may return some output parameter to the caller. Because an EXEC statement may be used, one way to pass the output value from @String in EXEC(@String) to the caller is to use a local temp table.

Specific permissions that generated SPs (e.g. such as the received procedure) are expected to perform may be granted. That is what SP bsp_AssignPermissions may do. In the above example, if this is done before execute bsp_test3: “grant select on dbo.D_Time to PPSPlanning2007LowPrivilegeSQLUser”, then when the SP executed, the data may be received from D_Time table.

TABLE 1 lists the permissions embodiments of the invention may grant to the user PPSPlanning2007LowPrivilegeSQLUser on the DB objects in dbo schema (e.g. second schema 115). These permissions may only be for the database objects in the dbo schema (e.g. second schema 115,) not for any database objects in the Calc schema (e.g. first schema 119). Once computing device 300 executes the received procedure in stage 270, method 200 may then end at stage 280.

TABLE 1

| ObjectType and Prefix | Permissions |
|---|---|
| Table: D_{—} | select |
| Table: H_{—} | select |
| Table: NS_{—} | select |
| Table: A_{—} | select, delete |
| Table: AG_{—} | select |
| Table: L_{—} | select, delete |
| Table: MG_{—} | select, delete, update, insert |
| Table: Sec_{—} | select |
| View: D_{—} | select |
| View: Sec_{—} | select |
| Proc: bsp_GeneratedCalc | exec |
| Proc: bsp_IDGenGetUpdate | exec |
| Proc: bsp_QE | exec |
| Proc: bsp_SA | exec |
| Proc: bsp_Sec | exec |
| Proc: bsp_SU | exec |
| Proc: bsp_SW | exec |
| Proc: bsp_Validate | exec |
| Func: fn_{—} | exec |
| Func: fnCalc | exec |

Following are five test cases providing examples consistent with embodiments of the invention. The following Test Case 1 is the example of SP (bsp_test3) that is generated. This SP is trying to do something that it does not have permission to do.

```
declare @string nvarchar(max)
set @String = N'
  create proc Calc.bsp_test4
  --with execute as “PPSPlanning2007LowPrivilegeSQLUser”
  As
                UPDATE dbo.D_Time
                SET MemberID = 999
-- Calc module uses bsp_CreateExecuteSP to create the bsp_test3
exec dbo.bsp_CreateExecuteSP
@String = @String
Go
```

Now, bsp_test3 is executed.

declare @rule_cmd nvarchar(2000)
set @rule_cmd = N'exec Calc.bsp_test3'
exec dbo.bsp_CreateExecuteSP
@String = @rule_cmd

The above execution will get an error message because there is no permission.

The following Test Case 2 illustrates a malicious user who is trying to drop dbo.D_Time table. The following is the example of SP (bsp_test3) that is generated.

```
declare @string nvarchar(max)
set @String = N'
  create proc Calc.bsp_test4
  --with execute as “PPSPlanning2007LowPrivilegeSQLUser”
  as
                drop table dbo.D_Time
-- Calc module uses bsp_CreateExecuteSP to create the bsp_test3
exec dbo.bsp_CreateExecuteSP
@String = @String
Go
```

Now, execute bsp_test3 may be executed.

declare @rule_cmd nvarchar(2000)
set @rule_cmd = N'exec Calc.bsp_test3'
exec dbo.bsp_CreateExecuteSP
@String = @rule_cmd

Consequently, the following error message may be received “Cannot drop the table ‘D_Time’”, because it does not exist or the malicious user does not have permission.

The following Test Case 3 illustrates a user trying to alter the special SP.

declare @alter_proc nvarchar(2000)
set @alter_proc = N'alter proc dbo.bsp_CreateExecuteSP
@String nvarchar(max)
WITH EXECUTE AS “dbo”
AS
EXECUTE(@String)'
exec dbo.bsp_CreateExecuteSP
@String = @alter_proc
Go

Once executed, this will fail giving the error message “Cannot alter the procedure ‘bsp_CreateExecuteSP9’, because it does not exist or you do not have permission.”

The following Test Case 4 illustrates a user trying to create a stored procedure in the dbo schema.

```
select user_name( ) -- dbo
EXECUTE AS User = ‘PPSPlanning2007LowPrivilegeSQLUser’
GO
select user_name( ) -- PPSPlanning2007LowPrivilegeSQLUser
CREATE PROC dbo.bsp_test20
  as
                select * from dbo.D_Time
GO
```

Once executed, this will fail giving the error message “The specified schema name “dbo” either does not exist or you do not have permission to use it.”

The following Test Case 5 illustrates a user trying to create a table or function in the dbo schema.

select user_name( ) -- dbo
EXECUTE AS User = ‘PPSPlanning2007LowPrivilegeSQLUser’
GO
select user_name( ) -- PPSPlanning2007LowPrivilegeSQLUser
CREATE TABLE dbo.test1_calc
(col1 int)
GO

Once executed, this will fail giving the error message “The specified schema name “dbo” either does not exist or you do not have permission to use it.” However, if the following is done first:

GRANT ALTER ON SCHEMA::dbo TO
PPSPlanning2007LowPrivilegeSQLUser

the above Test Case 5 will be able to create dbo.test1_calc table without any error. This illustrates the importance of DENY ALTER ON SCHEMA::dbo TO PPSPlanning2007LowPrivilegeSQLUser.

An embodiment consistent with the invention may comprise a system for providing secure database access. The system may comprise a memory storage and a processing unit coupled to the memory storage. The processing unit may be operative to define a first schema associated with a database having a second schema and to define a user type. Moreover, the processing unit may be operative to associate the defined user type with the defined first schema. In addition, the processing unit may be operative to grant at least one permission to the user type to the database on a database level and to deny permission to the user type to the second schema.

Another embodiment consistent with the invention may comprise a system for providing secure database access. The system may comprise a memory storage and a processing unit coupled to the memory storage. The processing unit may be operative to define a user type and to associate the defined user type with a first schema. Furthermore, the processing unit may be operative to grant at least one permission to the user type to a database on a database level. Moreover, the processing unit may be operative to deny all permissions to the user type to a second schema associated with the database and to grant at least one permission to the user type to the second schema.

Yet another embodiment consistent with the invention may comprise a system for providing secure database access. The system may comprise a memory storage and a processing unit coupled to the memory storage. The processing unit may be operative to define a first schema associated with a database having a second schema. The second schema may have more permissions to the database than the first schema. In addition, the processing unit may be operative to define a user type that does not require a login and to associate the defined user type with the defined first schema. Moreover, the processing unit may be operative to grant at least one permission to the user type to the database on a database level. The at least one permission may comprise, but is not limited to, a create procedure permission, a create table permission, or a create function permission. Furthermore, the processing unit may be operative to deny permission to the user type to the second schema by disallowing the user type to view metadata of database objects in second schema. Also, the processing unit may be operative to receive a procedure that poses a high security risk to the database and to execute, using a wrapper procedure, the received procedure as the defined user type.

FIG. 3 is a block diagram of a system including computing device 300. Consistent with an embodiment of the invention, the aforementioned memory storage and processing unit may be implemented in a computing device, such as computing device 300 of FIG. 3. Any suitable combination of hardware, software, or firmware may be used to implement the memory storage and processing unit. For example, the memory storage and processing unit may be implemented with computing device 300 or any of other computing devices 318, in combination with computing device 300. The aforementioned system, device, and processors are examples and other systems, devices, and processors may comprise the aforementioned memory storage and processing unit, consistent with embodiments of the invention. Furthermore, computing device 300 may comprise an operating environment for operating environment 100 as described above. Operating environment 100 may operate in other environments and is not limited to computing device 300.

With reference to FIG. 3, a system consistent with an embodiment of the invention may include a computing device, such as computing device 300. In a basic configuration, computing device 300 may include at least one processing unit 302 and a system memory 304. Depending on the configuration and type of computing device, system memory 304 may comprise, but is not limited to, volatile (e.g. random access memory (RAM)), non-volatile (e.g. read-only memory (ROM)), flash memory, or any combination. System memory 304 may include operating system 305, one or more programming modules 306, and may include a program data 307 and database 105. Operating system 305, for example, may be suitable for controlling computing device 300's operation. In one embodiment, programming modules 306 may include, for example secure database application 320. Furthermore, embodiments of the invention may be practiced in conjunction with a graphics library, other operating systems, or any other application program and is not limited to any particular application or system. This basic configuration is illustrated in FIG. 3 by those components within a dashed line 308.

Computing device 300 may have additional features or functionality. For example, computing device 300 may also include additional data storage devices (removable and/or non-removable) such as, for example, magnetic disks, optical disks, or tape. Such additional storage is illustrated in FIG. 3 by a removable storage 309 and a non-removable storage 310. Computer storage media may include volatile and nonvolatile, removable and non-removable media implemented in any method or technology for storage of information, such as computer readable instructions, data structures, program modules, or other data. System memory 304, removable storage 309, and non-removable storage 310 are all computer storage media examples (i.e. memory storage). Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 300. Any such computer storage media may be part of device 300. Computing device 300 may also have input device(s) 312 such as a keyboard, a mouse, a pen, a sound input device, a touch input device, etc. Output device(s) 314 such as a display, speakers, a printer, etc. may also be included. The aforementioned devices are examples and others may be used.

Computing device 300 may also contain a communication connection 316 that may allow device 300 to communicate with other computing devices 318, such as over a network in a distributed computing environment, for example, an intranet or the Internet. Communication connection 316 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 304, including operating system 305. While executing on processing unit 302, programming modules 306 (e.g. secure database application 320) may perform processes including, for example, one or more method 200's stages as described above. The aforementioned process is an example, and processing unit 302 may perform other processes. Other programming modules that may be used in accordance with embodiments of the present invention may include electronic mail and contacts applications, word processing applications, spreadsheet applications, database applications, slide presentation applications, drawing or computer-aided application programs, etc.

Generally, consistent with embodiments of the invention, program modules may include routines, programs, components, data structures, and other types of structures that may perform particular tasks or that may implement particular abstract data types. Moreover, embodiments of the invention may be practiced with other computer system configurations, including hand-held devices, multiprocessor systems, microprocessor-based or programmable consumer electronics, minicomputers, mainframe computers, and the like. Embodiments of the invention may also be practiced in distributed computing environments where tasks are performed by remote processing devices that are linked through a communications network. In a distributed computing environment, program modules may be located in both local and remote memory storage devices.

Furthermore, embodiments of the invention may be practiced in an electrical circuit comprising discrete electronic elements, packaged or integrated electronic chips containing logic gates, a circuit utilizing a microprocessor, or on a single chip containing electronic elements or microprocessors. Embodiments of the invention may also be practiced using other technologies capable of performing logical operations such as, for example, AND, OR, and NOT, including but not limited to mechanical, optical, fluidic, and quantum technologies. In addition, embodiments of the invention may be practiced within a general purpose computer or in any other circuits or systems.

Embodiments of the invention, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present invention may be embodied in hardware and/or in software (including firmware, resident software, micro-code, etc.). In other words, embodiments of the present invention may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present invention, for example, are described above with reference to block diagrams and/or operational illustrations of methods, systems, and computer program products according to embodiments of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the invention have been described, other embodiments may exist. Furthermore, although embodiments of the present invention have been described as being associated with data stored in memory and other storage mediums, data can also be stored on or read from other types of computer-readable media, such as secondary storage devices, like hard disks, floppy disks, or a CD-ROM, a carrier wave from the Internet, or other forms of RAM or ROM. Further, the disclosed methods' stages may be modified in any manner, including by reordering stages and/or inserting or deleting stages, without departing from the invention.

All rights including copyrights in the code included herein are vested in and the property of the Applicant. The Applicant retains and reserves all rights in the code included herein, and grants permission to reproduce the material only in connection with reproduction of the granted patent and for no other purpose.

While the specification includes examples, the invention's scope is indicated by the following claims. Furthermore, while the specification has been described in language specific to structural features and/or methodological acts, the claims are not limited to the features or acts described above. Rather, the specific features and acts described above are disclosed as example for embodiments of the invention.

What is claimed is:

1. A method for providing secure database access, the method comprising:
defining a first schema associated with a database having a second schema;
defining a user type;
associating the defined user type with the defined first schema;
granting at least one permission to the user type to the database on a database level; and
denying permission to the user type to the second schema.

2. The method of claim 1, wherein granting the at least one permission comprises granting the at least one permission comprising a necessary permission comprising only enough authority needed by the user type to perform a predetermined job in the first schema.

3. The method of claim 1, wherein associating the defined user type with the defined first schema comprises authorizing the defined user type to access only to the first schema.

4. The method of claim 1, wherein denying permission to the user type to the second schema comprises disallowing the user type to view metadata of database objects in second schema.

5. The method of claim 1, further comprising:
receiving a procedure; and
executing the received procedure as the defined user type.

6. The method of claim 5, wherein receiving the procedure comprises receiving the procedure that poses a high security risk to the database.

7. The method of claim 5, wherein executing the received procedure comprises executing the received procedure using a wrapper procedure.

8. The method of claim 1, further comprising:
receiving a procedure; and
executing the received procedure in the first schema.

9. The method of claim 8, wherein receiving the procedure comprises receiving the procedure that poses a high security risk to the database.

10. The method of claim 1, further comprising granting further permissions to the user type to the database on the database level configured to relax a security level of the user type to the database.

11. A computer-readable medium which stores a set of instructions which when executed performs a method for providing secure database access, the method executed by the set of instructions comprising:
defining a user type;
associating the defined user type with a first schema;
granting at least one permission to the user type to a database on a database level;
denying all permissions to the user type to a second schema associated with the database; and
granting at least one permission to the user type to the second schema.

12. The computer-readable medium of claim 11, wherein granting the at least one permission to the user type to the second schema comprises granting at the least one permission only for database objects in the second schema and not for database objects in the first schema.

13. The computer-readable medium of claim 11, wherein granting the at least one permission to the user type comprises granting the at least one permission comprising a create procedure permission.

14. The computer-readable medium of claim 11, wherein granting the at least one permission to the user type comprises granting the at least one permission comprising a create table permission.

15. The computer-readable medium of claim 11, wherein granting the at least one permission to the user type comprises granting the at least one permission comprising a create function permission.

16. The computer-readable medium of claim 11, further comprising defining the first schema wherein defining the first schema comprises defining the first schema wherein the second schema has more permissions to the database than the first schema.

17. The computer-readable medium of claim 11, wherein denying all the permissions to the user type to the second schema associated with the database comprises disallowing the user type to view metadata of database objects in second schema.

18. The computer-readable medium of claim 11, further comprising:
receiving a procedure comprising a procedure that poses a high security risk to the database; and
executing the received procedure as the defined user type wherein executing the received procedure comprises executing the received procedure using a wrapper procedure.

19. The computer-readable medium of claim 11, further comprising:
receiving a procedure comprising a procedure that poses a high security risk to the database; and
executing the received procedure in the first schema.

20. A system for providing secure database access, the system comprising:
a memory storage; and
a processing unit coupled to the memory storage, wherein the processing unit is operative to:
define a first schema associated with a database having a second schema wherein the second schema has more permissions to the database than the first schema;
define a user type that does not require a login;
associate the defined user type with the defined first schema;
grant at least one permission to the user type to the database on a database level, the at least one permission comprising one of the following: a create procedure permission, a create table permission, and a create function permission;
deny permission to the user type to the second schema by disallowing the user type to view metadata of database objects in second schema;
receive a procedure that poses a high security risk to the database; and
execute, using a wrapper procedure, the received procedure as the defined user type.
